(19) United States
(12) Patent Application Publication
(10) Pub. No.: US 2018/0351913 A1
(43) Pub. Date: Dec. 6, 2018

(54) DETECTION SYSTEM, WEB APPLICATION DEVICE, WEB APPLICATION FIREWALL DEVICE, DETECTION METHOD FOR DETECTION SYSTEM, DETECTION METHOD FOR WEB APPLICATION DEVICE, AND DETECTION METHOD FOR WEB APPLICATION FIREWALL DEVICE

(71) Applicant: Panasonic Intellectual Property Management Co., Ltd., Osaka (JP)

(72) Inventors: TAKUROH YANAGIDA, Osaka (JP); KUNIO GOHARA, Osaka (JP); TOMOHIRO TAKAI, Kyoto (JP); KOUICHI KANEMURA, Osaka (JP)

(21) Appl. No.: 16/058,296

(22) Filed: Aug. 8, 2018

Related U.S. Application Data
(63) Continuation of application No. PCT/JP2017/002250, filed on Jan. 24, 2017.

(30) Foreign Application Priority Data
Feb. 29, 2016 (JP) 2016-038448
Apr. 15, 2016 (JP) 2016-082462

(51) Int. Cl. H04L 29/06; H04L 29/08

(52) U.S. Cl. CPC H04L 63/0245; H04L 67/02

(57) ABSTRACT

The web application firewall device includes a determination unit for determining whether or not the request is an invalid parameter and an analysis receiver. The web application device includes a controller for determining whether or not the request is a valid parameter and a response generation unit for generating a response. The determination unit updates the data for filtering the parameter based on the invalid information. The response generation unit selectively generates these responses including invalid information and valid information to transmit to the web application firewall device.

“This application is a continuation of the PCT International Application No. PCT/JP2017/002250 filed on Jan. 24, 2017, which claims the benefit of foreign priority of Japanese patent application No. 2016-038448, 2016-082462 filed on Feb. 29, 2016, Apr. 15, 2016, the contents all of which are incorporated herein by reference.”

### TECHNICAL FIELD

The present disclosure relates to a detection system, a web application device, a web application firewall device, a detection method for a detection system, a detection method for a web application device, and a detection method for a web application firewall device, which avoid attacks from a network.

### BACKGROUND ART

Conventionally, a communication information monitoring device checks a parameter of a request from a client (request message) based on a preset check rule, determines that the request is an attack, and eliminates this request (see, for example, PTL 1).

In addition, a malware analysis system automatically generates a signature when a malware candidate sample (invalid parameter) is determined to be malware (see, for example, PTL 2).

### CITATION LIST

### Patent Literature

PTL 1: Unexamined Japanese Patent Publication No. 2007-4685
PTL 2: Unexamined Japanese Patent Publication No. 2014-519113

### SUMMARY OF THE INVENTION

An aspect of a detection system includes: a web application firewall device configured to filter a request from a web client; and a web application device configured to transmit a response corresponding to the filtered request. The web application firewall device includes: a first controller configured to receive the request sent from the web client to determine whether or not the request is valid; and an analysis receiver configured to receive the response corresponding to the request from the web application device to analyze. The web application device includes: a second controller configured to receive the request transmitted from the web application firewall device to determine whether or not the request is valid; and a response generation unit configured to generate the response corresponding to the request to transmit the response to the web application firewall device. Then, the response corresponding to the request includes a determination result as to whether or not the request is valid. The first controller includes a determination unit configured to receive the request including a parameter sent from the web client to determine whether or not the request includes the parameter being invalid. A first storage unit configures to be storing data for filtering the request including the parameter being invalid of the web client. A generation unit configured to generate the data. When the analysis receiver extracts invalid information being information on the parameter being invalid from the response, the determination unit blocks the request including the parameter being invalid by updating the data stored in the first storage unit to filter the request. When extracting the invalid information from the response, the analysis receiver transmits the invalid information to the generation unit. The generation unit generates the data from the invalid information and the parameter being invalid.

In addition, a web application device according to an aspect of the present disclosure is a web application device configured to transmit a response corresponding to a filtered request and includes a second controller and a response generation unit. The second controller receives a request including a parameter transmitted from the web application firewall device to determine whether or not the request includes a valid parameter. The response generation unit generates a response corresponding to the request to transmit the response to the web application firewall device. Then, when the second controller determines that the parameter is invalid, the response generation unit stores invalid information being information on the parameter being invalid in the response, and when the second controller determines that the parameter is valid, the response generation unit stores valid information being information on the parameter being valid in the response. Furthermore, the response generation unit generates a response including invalid information or a response including valid information to transmit to the web application firewall device.

In addition, a web application firewall device according to an aspect of the present disclosure is a web application firewall device configured to filter a request from a web client, and includes a first controller, an analysis receiver, and a first storage unit. The first controller receives the request sent from the web client to determine whether or not the request is valid. The analysis receiver receives a response from the web application device to analyze. The first storage unit stores data for blocking the request of the web client. Then, the first controller includes a determination unit, a generation unit, and a regulation unit. The determination unit receives the request including a parameter sent from the web client to determine whether or not the request includes the parameter being invalid. The generation unit generates a signature for blocking the parameter being invalid from the request. The regulation unit stores a regulation for blocking the parameter being invalid from the signature in the first storage unit. Furthermore, when invalid information is included in the response sent from the web application device, the analysis receiver transmits the invalid information to the generation unit.

In addition, a detection method for a detection system according to an aspect of the present disclosure is a detection method for a detection system including a web application firewall device for filtering a request from a web client and a web application device for transmitting a response corresponding to the filtered request. The detection method for a detection system includes, in the web application firewall device, a first determination step of receiving a request including a parameter sent from a web client to determine whether or not the request includes a valid parameter, and an analysis reception step of receiving a response corresponding to the request from the web application device to analyze. In the first determination step, when invalid information being information on an invalid parameter is extracted from the response in the analysis reception step, the data for filtering the parameter is updated. The detection method for a detection system further includes, in the web application device, a second determination step of receiving a request including a parameter transmitted from the web application firewall device to determine whether or not the request includes a valid parameter, and a response generation step of generating a response corresponding to the request to transmit the response to the web application firewall device. In the response generation step, a response including invalid information or a response including valid information being information on a valid parameter is generated to be transmitted to the web application firewall device.

In addition, the detection method for a web application device according to an aspect of the present disclosure is a detection method for a detection system including a web application device for transmitting a response corresponding to a filtered request. The detection method for a web application device includes transmitting a response including information for filtering the request in the header from the web application device to the web application firewall device.

In addition, the detection method for a web application firewall device according to an aspect of the present disclosure is a detection method for a web application firewall device for filtering a request from the web client. When the analysis receiver for receiving a response including, in the header, information for filtering the request from the web application device to analyze, extracts invalid information being information on an invalid parameter from the response, the detection method for a web application firewall device includes updating the data for filtering the request.

In order to filter the web client issuing the request, the web application firewall device uses at least an IP address or an identifier for uniquely specifying the web client as the information transmitted from the web application device to the web application firewall device. The identifier for uniquely specifying the web client may be an ID included in the internal firmware by the web client itself, may be an ID uniquely assigned by the web server to the web client, or may be a session ID uniquely assigned by the web server based on login information from the web client.

According to the present disclosure, the determination, generation, and analysis described above can be achieved continuously and promptly, and server security can be stably ensured. In addition, even an unknown attack can be prevented beforehand. In addition, requests including valid parameters can be prevented from being erroneously blocked. Furthermore, the cost of system construction can be reduced.

### BRIEF DESCRIPTION OF DRAWINGS

FIG. 1 is a block diagram showing a detection system of a first exemplary embodiment.

FIG. 2 is an explanatory diagram showing the detection system of the first exemplary embodiment.

FIG. 3 is a block diagram showing a web application firewall device in the detection system of the first exemplary embodiment.

FIG. 4 is a block diagram showing a web application device in the detection system of the first exemplary embodiment.

FIG. 5 is a sequence diagram showing an operation in the detection system of the first exemplary embodiment.

FIG. 6 is an explanatory diagram showing a determination of a controller of the web application device in the detection system of the first exemplary embodiment.

FIG. 7 is a block diagram showing a web application firewall device in a detection system of a second exemplary embodiment.

FIG. 8 is an explanatory diagram showing the detection system of the second exemplary embodiment.

FIG. 9 is a sequence diagram showing an operation in the detection system of the second exemplary embodiment.

FIG. 10 is a conceptual diagram showing the detection system of the second exemplary embodiment.

FIG. 11 is an explanatory diagram showing a determination of a controller of a web application device in a detection system.

### DESCRIPTION OF EMBODIMENTS

### Knowledge Underlying the Present Invention

As the provision of services through a network such as the Internet, for example, there is a web application device. When using the service, a web client transmits a request to the web application device through the network. Then, the web application device transmits a response to this request to the web client.

When a request including an invalid parameter exploiting the vulnerability of the web application device is transmitted from the web client, the request affects the web application device, which may cause a malfunction or the like. For this reason, an invalid parameter included in the request is blocked through the web application firewall device, so that the web application device is protected.

Conventionally, the web application firewall device is known to block attack patterns such as SQL injection and Distributed Denial of Service attack (DDos attack) as an attack pretending valid parameters.

In the web application firewall device, a blacklist method and a whitelist method are known as a method for determining whether or not an attack is made.

The blacklist method is a method of preventing attacks beforehand by checking a blacklist being information on an invalid (non-executable) parameter prestored in the web application firewall device against a parameter of a request and blocking the request when the checking results in matching. This blacklist method has a problem that unknown attacks not described in this data are received unless the prestored data is periodically updated. In addition, even if the blacklist is periodically updated, there is also a problem that the burden due to the investigation of the attack patterns and the like increases.

On the other hand, the whitelist method checks a whitelist being information on a valid (executable) parameter prestored in the web application firewall device against a parameter of a request and determines the request as an invalid parameter unless the comparison results in matching. Although it can be said that a security strength of this whitelist method is higher than that of the blacklist method, there is a problem that it is difficult to define a whitelist for each parameter and an operation burden increases. For these reasons, the blacklist method is currently the mainstream.

However, in the web application firewall device using the conventional blacklist method, an unknown attack not prestored as a blacklist (first attack) cannot be prevented. In addition, even if the request includes a valid parameter, there is also a problem that the request is erroneously blocked (erroneously detected).

For this reason, it is required that even an unknown attack can be prevented beforehand, a request having a valid parameter can be prevented from being erroneously blocked, and a cost of system construction can be reduced.

Thus, from the above-described problems, we examined a detection system, a web application device, a web application firewall device, a detection method for a detection system, a detection method for a web application device, and a detection method for a web application firewall device.

Hereinafter, exemplary embodiments will be described in detail with reference to the drawings as appropriate. However, a detailed description more than necessary may be omitted. For example, a detailed description of already well-known matters and an overlapping description of substantially the same configuration may be omitted. This is to avoid the following description from becoming unnecessarily redundant, and to ease the understanding of those skilled in the art.

It should be noted that the attached drawings and the following description are provided, by the inventors, for those skilled in the art to fully understand the present disclosure, and are not intended to limit the subject matter described in the appended claims.

It should be noted that each drawing is not necessarily illustrated precisely. In addition, in each drawing, substantially the same configuration is denoted by the same reference numeral, and an overlapping description will be omitted or simplified.

### First Exemplary Embodiment

Here, as a first exemplary embodiment of the present disclosure, detection system 1 according to the present disclosure will be described with reference to the drawings.

### Configuration of Entire Detection System

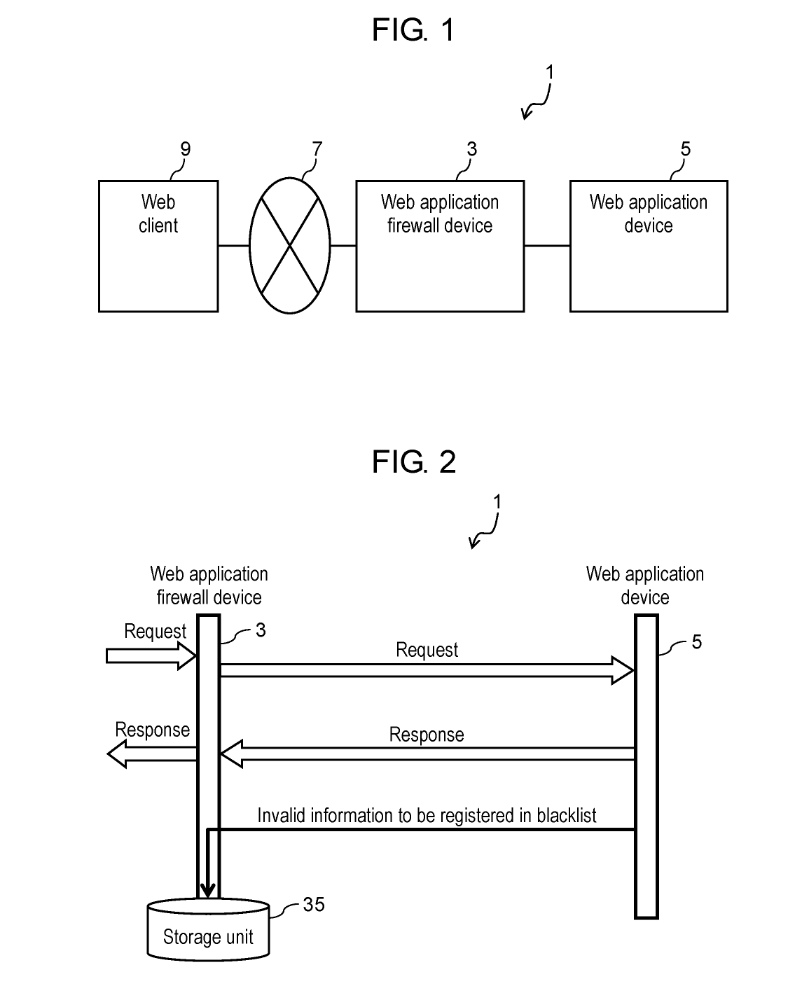

FIG. 1 is a block diagram showing detection system 1 of a first exemplary embodiment.

As shown in FIG. 1, detection system 1 includes web application firewall device 3 and web application device 5. Web application firewall device 3 and web application device 5 can be achieved by using, for example, an information processing device.

Web application firewall device 3 filters parameters included in the request from web client 9 in order to prevent attack on web application device 5. Web application firewall device 3 is connected to network 7 such as the Internet through a communication unit and is connected to web client 9 through network 7. Parameters included in the request are, for example, a security ID, a cookie including the security ID, and the like.

FIG. 2 is an explanatory diagram showing detection system 1 of the first exemplary embodiment.

As shown in FIG. 2, the request from web client 9 in FIG. 1 is filtered by web application firewall device 3 through network 7 in FIG. 1. The request filtered by web application firewall device 3 is transmitted to web application device 5. Web application device 5 transmits a response to the request to web application firewall device 3. Web application firewall device 3 transmits the response to web client 9 in FIG. 1 through network 7 in FIG. 1. As indicated by the solid arrow, when web application device 5 detects an invalid parameter included in the request, web application device 5 feeds back invalid information being invalid parameter information to storage unit 35 of web application firewall device 3 (first storage unit) in order to block requests including invalid parameters in the future. That is, the invalid information is registered in the blacklist, and the blacklist is updated. It should be noted that requests and responses are transmitted using HTTP communication.

Web application firewall device 3 uses at least an IP address or an identifier for uniquely specifying web client 9 as invalid information to be registered in the blacklist. The identifier for uniquely specifying web client 9 may be an ID included in the internal firmware by web client 9 itself, may be an ID uniquely assigned by the web server to web client 9, or may be a session ID uniquely assigned by the web server based on login information from web client 9.

### Configuration of Web Application Firewall Device

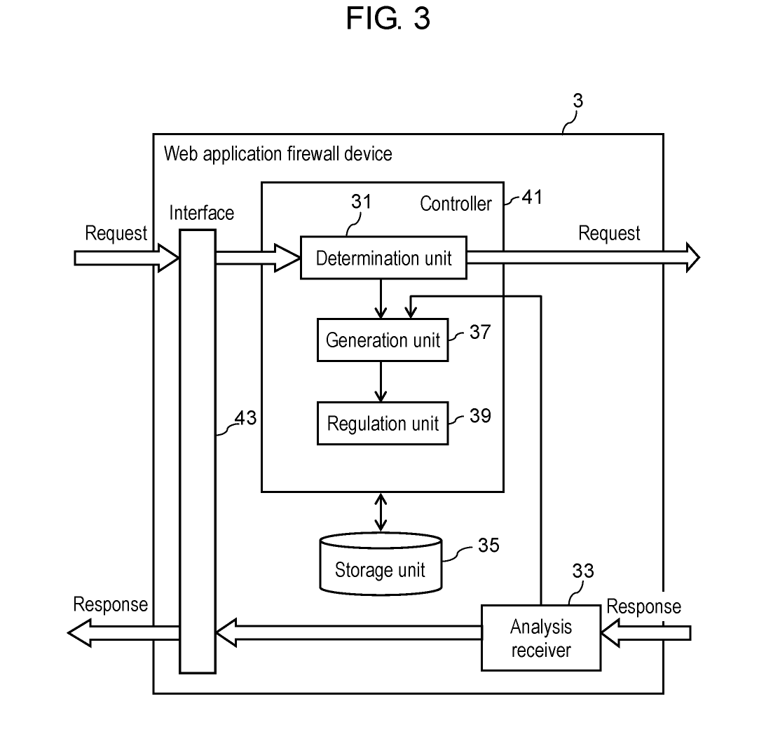

FIG. 3 is a block diagram showing web application firewall device 3 in detection system 1 of the first exemplary embodiment.

As shown in FIG. 3, web application firewall device 3 includes analysis receiver 33, storage unit 35 (first storage unit), a controller 41 (first controller), and interface 43. In addition, controller 41 includes determination unit 31, generation unit 37, and regulation unit 39.

Determination unit 31 receives a request including a parameter sent from web client 9. Determination unit 31 inspects a request line such as a method and a URI, a header such as a general header and a request header, and the like. Determination unit 31 determines whether or not the request includes an invalid parameter. In other words, determination unit 31 determines whether or not a blacklist stored in storage unit 35 and a parameter of a request match. When analysis receiver 33 extracts invalid information from a response, determination unit 31 updates the data for filtering the parameters stored in storage unit 35 (updates the regulation described below generated by regulation unit 39).

Analysis receiver 33 receives a response from web application device 5 that performs a response corresponding to a request and analyzes whether the information included in the response is invalid information or valid information being information on a valid parameter. Analysis receiver 33 analyzes, for example, a status code of a response, a response header, and the like. Analysis receiver 33 transmits invalid information to generation unit 37 when invalid information is extracted from the response. On the other hand, when valid information is extracted from the response, analysis receiver 33 transmits a response including the valid information to web client 9 through interface 43.

Storage unit 35 is implemented by a nonvolatile recording medium such as a hard disk drive (HDD), for example. Storage unit 35 stores data for blocking a request including an invalid parameter from web client 9. The data in storage unit 35 includes a blacklist such as an invalid parameter, a regulation (rule) for blocking a request including an invalid parameter, and an error log which is to be blocked. This error log is used later for analyzing the error stored in storage unit 35.

Generation unit 37 generates a signature for blocking an invalid parameter from the parameter error-handled by determination unit 31 or the invalid information.

Regulation unit 39 defines a regulation (rule) for blocking a request including an invalid parameter from a signature in order to detect a request including an invalid parameter.

Controller 41 updates this regulation to store in storage unit 35. Controller 41 is a control circuit in which a CPU, a main memory, and the like are stored. The main memory is a storage medium such as a dynamic random access memory (DRAM), for example.

### Configuration of Web Application Device

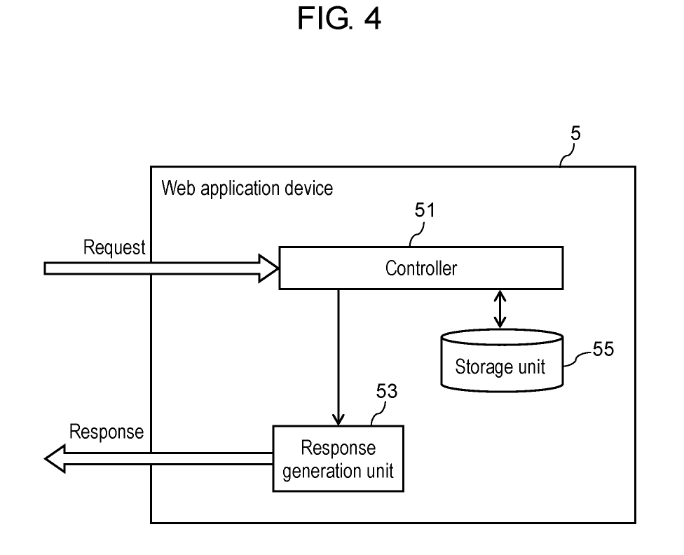

FIG. 4 is a block diagram showing web application device 5 in detection system 1 of the first exemplary embodiment.

As shown in FIG. 4, web application device 5 transmits an HTTP response corresponding to a filtered request to web application firewall device 3. Web application device 5 includes controller 51 (second controller), response generation unit 53, and storage unit 55 (second storage unit).

Controller 51 receives a request including a parameter transmitted from web application firewall device 3 to determine whether or not the request includes a valid parameter. In other words, controller 51 determines whether or not a whitelist stored in storage unit 55 and a parameter of a request match. Storage unit 55 stores data for blocking a request including an invalid parameter from web client 9. The data in storage unit 55 in web application device 5 includes a whitelist such as a valid parameter. It should be noted that storage unit 55 may be provided in controller 51.

When determining that a whitelist and a parameter of a request do not match, controller 51 registers detected invalid information in a header of a response. The invalid information includes a login authentication failure count, detection date and time, a selected processing method, a source IP address, a destination URL, and a header determined to be invalid.

In addition, when a whitelist and a parameter of a request match, controller 51 registers valid information being information on a detected valid parameter in a header of a response.

Response generation unit 53 selectively generates a response including invalid information and a response including valid information to transmit to web application firewall device 3. That is, response generation unit 53 generates a response including invalid information or a response including valid information (a response corresponding to the request) to transmit the response to web application firewall device 3. Response generation unit 53 generates a response including invalid information when controller 51 determines that the parameter of the request is an invalid parameter and generates a response including valid information when controller 51 determines that the parameter of the request is a valid parameter.

### Operation

Operations of detection system 1, web application device 5, web application firewall device 3, a detection method for detection system 1, a detection method for web application device 5, and a detection method for web application firewall device 3 as configured above will be described below.

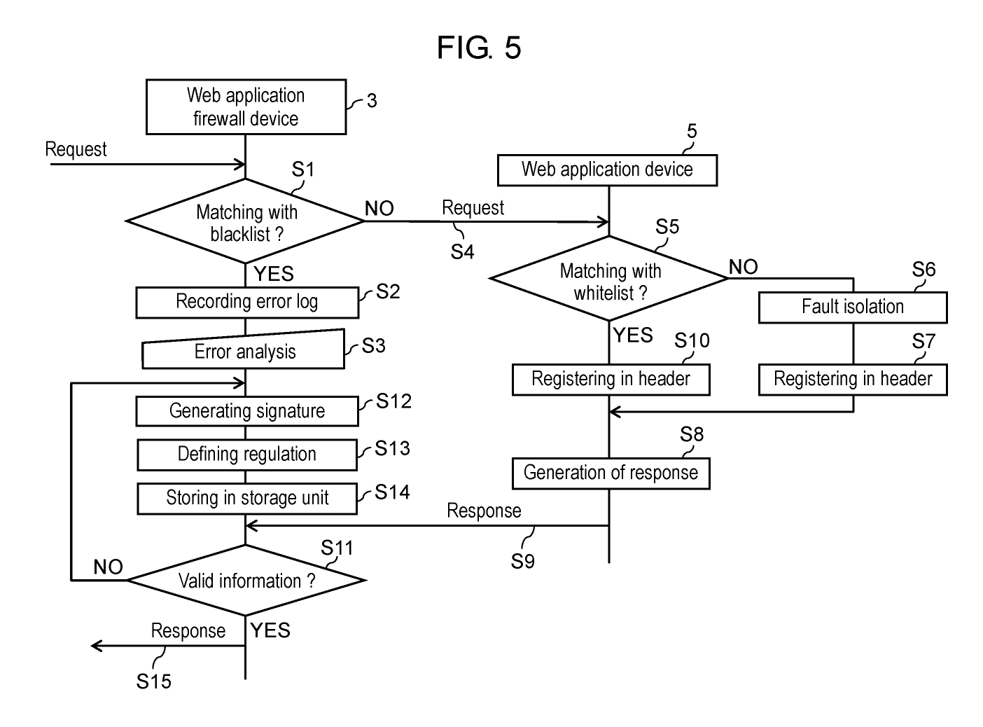

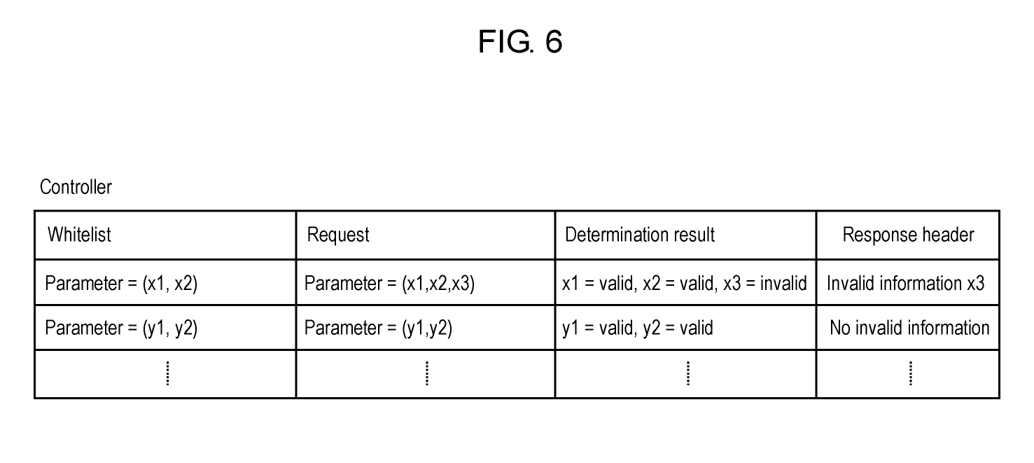

FIG. 5 is a sequence diagram showing an operation in detection system 1 of the first exemplary embodiment. FIG. 6 is an explanatory diagram showing a determination of controller 51 of web application device 5 in detection system 1 of the first exemplary embodiment.

As shown in FIGS. 1 and 5, web application firewall device 3 receives a request from web client 9. Determination unit 31 of web application firewall device 3 determines whether or not the parameter of this request and the blacklist stored in storage unit 35 (first storage unit) match (first determination step S1).

If the parameter of this request and the blacklist stored in storage unit 35 match (YES in S1), determination unit 31 stores a parameter handled as an error (invalid parameter) as an error log in storage unit 35 (S2). It should be noted that for the invalid parameter, the error stored in storage unit 35 is analyzed (S3).

It should be noted that if YES in step S1, web application firewall device 3 may notify web client 9 of an error indicating that an invalid parameter is detected. Then, analysis receiver 33 may transmit an error notification to web client 9.

If the parameter of this request and the blacklist stored in storage unit 35 do not match (NO in S1), determination unit 31 causes web application firewall device 3 to transmit the request including the parameter to web application device 5 (S4). That is, in web application firewall device 3, determination unit 31 adopts a blacklist method.

Next, controller 51 receives the request including the parameter transmitted from web application firewall device 3. Controller 51 determines whether or not the request includes a valid parameter (second determination step S5). In other words, controller 51 determines whether or not the whitelist and the parameter of the request match.

If the parameter of the request and the whitelist stored in storage unit 55 (second storage unit) do not match (NO in S5), controller 51 performs fault isolation in order to determine information such as which parameter is determined as not matching (S6) in a later operation. Controller 51 registers invalid information being information on a fault-isolated invalid parameter (S7).

For example, as shown in FIG. 6, assume that the parameters of the whitelist are (x1, x2) and the parameters of the request are (x1, x2, x3), then the determination result is x1=valid, x2=valid, and x3=invalid. In the header of the response, the fact that x3 being an impossible parameter exists is registered as invalid information. Then, as shown in FIG. 5, controller 51 transmits a response including invalid information to response generation unit 53.

Response generation unit 53 generates a response including invalid information (response generation step S8). Response generation unit 53 transmits a response including invalid information to analysis receiver 33 of web application firewall device 3 (S9, a detection method for web application device 5).

If the parameter of the request and the whitelist stored in storage unit 55 match (YES in S5), controller 51 treats the request as valid information being information on a valid parameter. That is, in this web application device 5, controller 51 adopts a whitelist method.

For example, as shown in FIG. 6, assume that the parameters of the whitelist are (y1, y2) and the parameters of the request are (y1, y2), then the determination result is y1=valid, and y2=valid. In the header of the response, a request including the parameters (y1, y2) is registered as valid information (S10 in FIG. 5). Then, as shown in FIG. 5, controller 51 transmits a response including valid information to response generation unit 53.

Response generation unit 53 generates a response including valid information (response generation step S8). Response generation unit 53 transmits valid information to analysis receiver 33 of web application firewall device 3 (S9, a detection method for web application device 5).

Analysis receiver 33 receives a response from response generation unit 53. Analysis receiver 33 analyzes whether or not valid information is included in the response (S11, analysis reception step). When valid information is not included (NO in S11), that is, when invalid information is included in the response, analysis receiver 33 transmits the invalid information to generation unit 37.

As shown in FIGS. 1 and 5, generation unit 37 generates a signature based on invalid information (S12) in order to filter a request including an invalid parameter from web client 9. In addition, generation unit 37 also generates a signature based on the error in step S3. Generation unit 37 transmits the generated signature to regulation unit 39.

Regulation unit 39 defines a regulation (rule) for blocking a request including an invalid parameter based on the signature (S13). Determination unit 31 stores a regulation for blocking the request in storage unit 35 (S14, a detection method for web application firewall device 3). That is, determination unit 31 of web application firewall device 3 blocks a request including the same parameter in the future by a new regulation being updated in storage unit 35.

It should be noted that determination unit 31 may notify web client 9 of an error indicating that an invalid parameter is detected. Then, determination unit 31 may transmit a notification of the error to web client 9. In addition, it should be noted that when detecting invalid information, analysis receiver 33 may perform block operation of not transmitting a response to web client 9.

When detecting valid information (YES in S12), analysis receiver 33 transmits a response corresponding to the request to web client 9 through interface 43 (S15).

### Operations and Effects

Next, the operations and effects of detection system 1, web application device 5, web application firewall device 3, a detection method for detection system 1, a detection method for web application device 5, and a detection method for web application firewall device 3 according to the present exemplary embodiment will be described.

As described above, detection system 1 according to the present exemplary embodiment includes web application firewall device 3 for filtering a request from web client 9 and web application device 5 for transmitting a response corresponding to the filtered request. Web application firewall device 3 includes determination unit 31 for receiving a request including a parameter sent from web client 9 to determine whether or not the request includes an invalid parameter, and analysis receiver 33 for receiving a response corresponding to the request from web application device 5 to analyze. Web application device 5 includes controller 51 for receiving a request including a parameter transmitted from web application firewall device 3 to determine whether or not the request includes a valid parameter. Furthermore, web application device 5 includes response generation unit 53 for generating a response corresponding to the request to transmit the response to web application firewall device 3. When analysis receiver 33 extracts invalid information being information on an invalid parameter from the response, determination unit 31 updates the data for filtering the parameter. Response generation unit 53 selectively generates a response including invalid information and a response including valid information being information on a valid parameter to transmit to web application firewall device 3.

According to this configuration, determination unit 31 can block invalid parameters and controller 51 can allow valid parameters. Determination unit 31 can update data for filtering parameters other than valid parameters extracted by controller 51. Thus, parameters other than the whitelist in web application device 5 can be regarded as invalid information, and this invalid information can be added to the blacklist in web application firewall device 3. In addition, a request including a valid parameter can pass through determination unit 31 and controller 51, and a response corresponding to this request can be transmitted to web client 9.

In addition, in this detection system 1, there is no need for a dedicated device for detecting an attack with a heuristic engine installed on a virtual machine or a physical machine for analysis, and it is difficult for the cost of system construction to increase.

Therefore, even an unknown attack can be prevented beforehand. In addition, requests including valid parameters can be prevented from being blocked. Furthermore, the cost of system construction can be reduced.

In addition, in detection system 1 according to the present exemplary embodiment, web application firewall device 3 further includes storage unit 35 for storing data for blocking requests including invalid parameters from web client 9 and generation unit 37 for generating data. In addition, when extracting invalid information from the response, analysis receiver 33 transmits the invalid information to generation unit 37. Then, determination unit 31 blocks a request including an invalid parameter by updating the data stored in storage unit 35 to filter a request.

According to this configuration, web application firewall device 3 and web application device 5 can cooperate with each other to automatically update the signature. The signature is automatically updated, which can be easily reflected in the data for blocking a request.

As described above, web application device 5 according to the present exemplary embodiment transmits a response corresponding to the filtered request. Web application device 5 includes controller 51 for receiving a request including a parameter transmitted from web application firewall device 3 to determine whether or not the request includes a valid parameter. Furthermore, web application device 5 includes response generation unit 53 for generating a response corresponding to the request to transmit the response to web application firewall device 3. When controller 51 determines that the request includes an invalid parameter, response generation unit 53 stores invalid information being information on an invalid parameter in the response. When controller 51 determines that the request includes a valid parameter, response generation unit 53 stores valid information being information on a valid parameter in the response. Response generation unit 53 generates a response including invalid information or a response including valid information to transmit to web application firewall device 3.

According to this configuration, the response can be divided into valid information being information on a valid parameter and invalid information being information on an invalid parameter being the parameter other than the valid parameter, and can be fed back to web application firewall device 3.

As described above, web application firewall device 3 according to the present exemplary embodiment filters requests from web client 9. Web application firewall device 3 includes determination unit 31 for receiving a request including a parameter sent from web client 9 to determine whether or not the request includes an invalid parameter, and analysis receiver 33 for receiving a response from web application device 5 to analyze. Furthermore, web application firewall device 3 includes storage unit 35 for storing data for blocking a request including an invalid parameter from web client 9, generation unit 37 for generating a signature for blocking an invalid parameter from the request, and regulation unit 39 for storing a regulation for blocking an invalid parameter from the signature in storage unit 35. When an invalid parameter is extracted, analysis receiver 33 transmits the invalid parameter to generation unit 37.

According to this configuration, web application firewall device 3 and web application device 5 can cooperate with each other to automatically update the regulation. In web application firewall device 3, the regulation is automatically updated, which can be easily reflected the regulation in the data for blocking a request. Therefore, even if there is a request including an invalid parameter again, the request can be blocked by web application firewall device 3. As a result, filtering of web application firewall device 3 can be strengthened.

In particular, in web application firewall device 3, even if the specification of web application device 5 is changed, this regulation can be automatically updated, so that flexible handling can be performed.

As described above, the detection method for detection system 1 according to the present exemplary embodiment includes web application firewall device 3 for filtering a request from web client 9 and web application device 5 for transmitting a response corresponding to the filtered request. In web application firewall device 3, a determination step of receiving a request including a parameter sent from web client 9 to determine whether or not the request includes a valid parameter, and an analysis reception step of receiving a response corresponding to the request from web application device 5 to analyze are included. In a first determination step, when analysis receiver 33 extracts invalid information being information on an invalid parameter from the response, the data for filtering the parameter is updated. The detection method for detection system 1 further includes, in web application device 5, a second determination step of receiving a request including a parameter transmitted from web application firewall device 3 to determine whether or not the request includes a valid parameter, and a response generation step of generating a response corresponding to the request to transmit the response to web application firewall device 3. In the response generation step, a response including invalid information or a response including valid information being information on a valid parameter is generated to be transmitted to web application firewall device 3.

According to this method, determination unit 31 blocks invalid parameters and controller 51 allows valid parameters. Determination unit 31 updates data for filtering parameters other than valid parameters extracted by controller 51. Thus, parameters other than the whitelist in the web application device are regarded as invalid information, and this invalid information is added to the blacklist in web application firewall device 3. In addition, a request including a valid parameter passes through determination unit 31 and controller 51, and a response corresponding to this request is transmitted to web client 9.

In addition, in this detection system 1, there is no need for a dedicated device for detecting an attack with a heuristic engine installed on a virtual machine or a physical machine for analysis, and it is difficult for the cost of system construction to increase.

Therefore, even an unknown attack can be prevented beforehand. In addition, requests including valid parameters can be prevented from being blocked. Furthermore, the cost of system construction can be reduced.

As described above, the detection method for web application device 5 according to the present exemplary embodiment includes web application device 5 for transmitting a response corresponding to the filtered request. The detection method for web application device 5 includes transmitting a response including information for filtering the request in the header from web application device 5 to web application firewall device 3.

According to this method, information to be filtered can be fed back to web application firewall device 3. Therefore, even an unknown attack can be prevented beforehand.

As described above, the detection method for web application firewall device 3 according to the present exemplary embodiment includes filtering requests from a web client. When analysis receiver 33 for receiving a response including, in the header, information for filtering the request from web application device 5 to analyze, extracts invalid information being information on an invalid parameter from the response, this detection method includes updating the data for filtering the request.

According to this method, analysis receiver 33 analyzes the response received from web application device 5 to extract invalid information to update the data for filtering the request. Therefore, the regulation for blocking the request can be easily reflected.

### Second Exemplary Embodiment

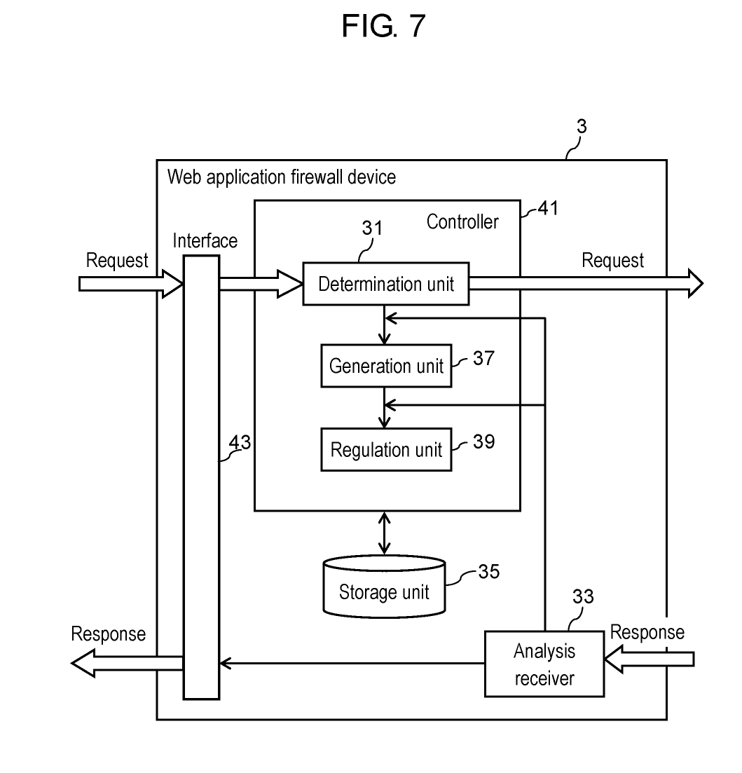

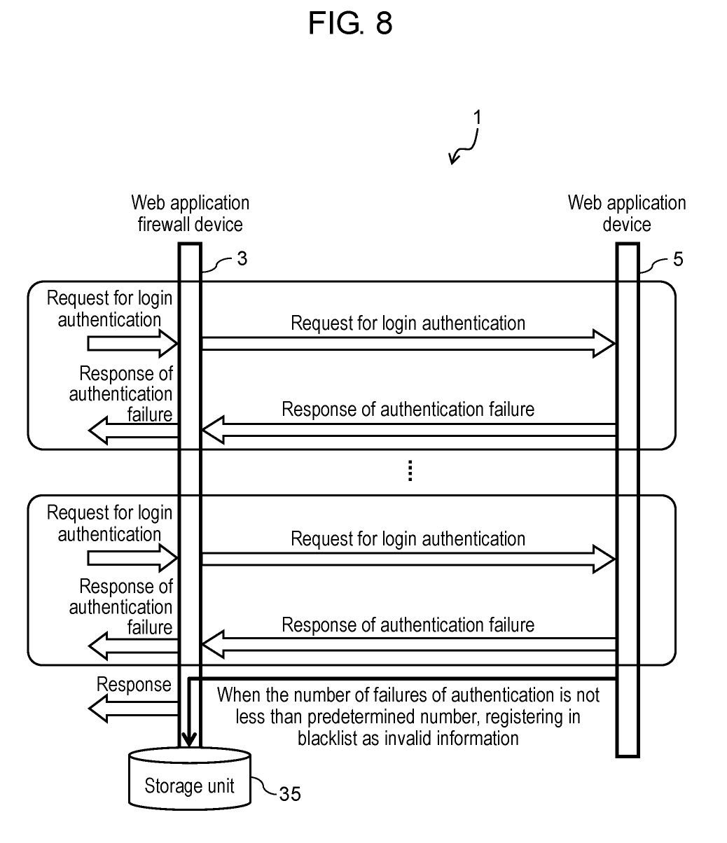

Next, as a second exemplary embodiment of the present disclosure, detection system 1 according to the present disclosure will be described with reference to FIGS. 7 and 8.

### Configuration

FIG. 7 is a block diagram showing web application firewall device 3 in detection system 1 of the second exemplary embodiment. FIG. 8 is an explanatory diagram showing detection system 1 of the second exemplary embodiment.

As shown in FIG. 7, other configurations of these detection system 1, web application device 5, web application firewall device 3, a detection method for detection system 1, a detection method for web application device 5, and a detection method for web application firewall device 3 are the same as detection system 1, web application device 5, web application firewall device 3, a detection method for detection system 1, a detection method for web application device 5, and a detection method for web application firewall device 3 of the first exemplary embodiment, and the same configurations are denoted by the same reference numerals, and a detailed description of the same configurations will be omitted.

There is a difference in that although analysis receiver 33 transmits invalid information to generation unit 37 in detection system 1 of the first exemplary embodiment, analysis receiver 33 transmits invalid information to generation unit 37 or regulation unit 39 in detection system 1 of the second exemplary embodiment.

As shown in FIG. 8, in detection system 1 of the second exemplary embodiment of the present disclosure, when web client 9 in FIG. 1 transmits a login-authentication request, web application firewall device 3 filters a parameter included in the login-authentication request. This parameter is registered in a cookie. Web application firewall device 3 transmits a login-authentication request to web application device 5. Web application device 5 counts the number of failures of the login authentication to register in the cookie, and transmits a response including the cookie to web application firewall device 3. Web application firewall device 3 transmits a response to web client 9 in FIG. 1.

When the number of failures of the login authentication reaches not less than a predetermined number, web application firewall device 3 blocks the request from web client 9. Web application firewall device 3 stores the invalid information to be registered in the blacklist in storage unit 35 and blocks the request from web client 9 in FIG. 1.

In addition, when the number of failures of the login authentication is less than the predetermined number and the login authentication succeeds, a response corresponding to the request is transmitted to web client 9 in FIG. 1.

### Operation

Operations of detection system 1, web application device 5, web application firewall device 3, a detection method for detection system 1, a detection method for web application device 5, and a detection method for web application firewall device 3 as configured above will be described below.

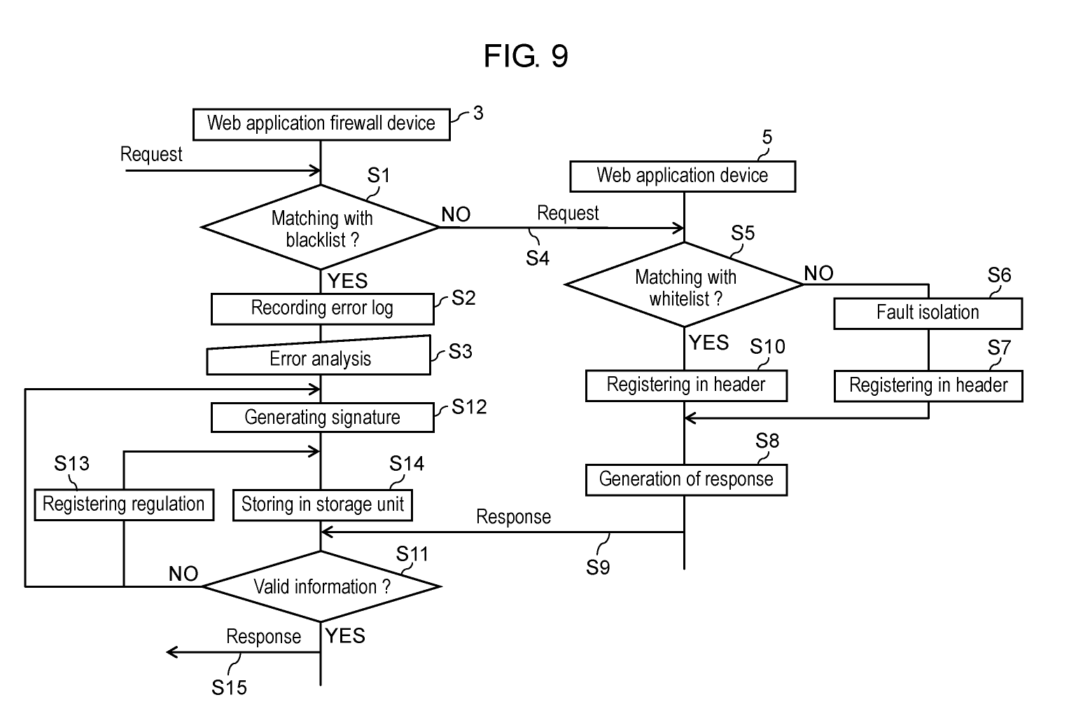

FIG. 9 is a sequence diagram showing an operation in detection system 1 of the second exemplary embodiment.

As shown in FIG. 9, since detection system 1 and the flow of steps S1 to S10 of the first exemplary embodiment are the same as detection system 1 and the flow of steps S1 to S10 in the second exemplary embodiment, the description of detection system 1 and the flow of steps S1 to S10 will be omitted. In step S11, analysis receiver 33 analyzes whether or not valid information is included in the response. If invalid information is included in the response (NO in S11), analysis receiver 33 transmits invalid information to generation unit 37 or regulation unit 39.

Generation unit 37 receives invalid information and generates a signature based on the invalid information in order to detect the request including the invalid parameter (S12). Determination unit 31 stores the generated signature in storage unit 35 (first storage unit). Regulation unit 39 defines a regulation (rule) for blocking a request including an invalid parameter based on the invalid information (S13). Determination unit 31 stores the regulation for blocking the request in storage unit 35 (S14). Thus, a new regulation is updated in storage unit 35, so that when a request including the same parameter is transmitted again, determination unit 31 of web application firewall device 3 blocks the request without sending to web application device 5.

When detecting valid information (YES in S11), analysis receiver 33 transmits a response corresponding to the request to web client 9 through interface 43 (S15).

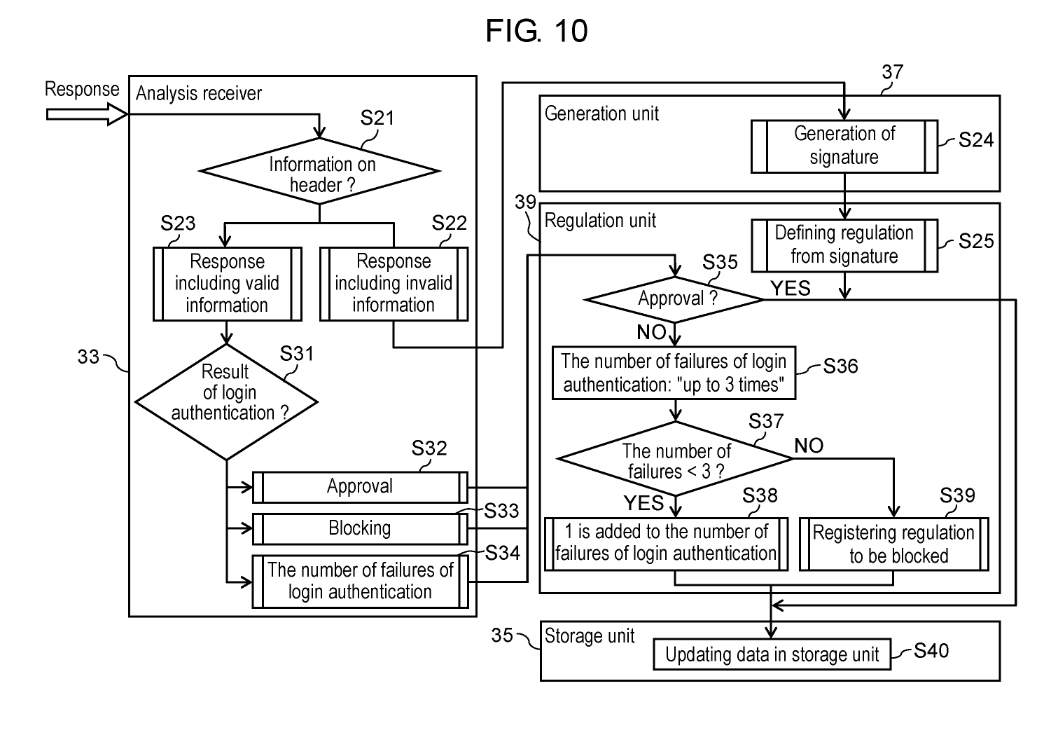

Next, step S11 of analysis receiver 33, step S12 of generation unit 37, step S13 of regulation unit 39, and step S14 of storing a regulation in storage unit 35 in FIG. 9 will be described below with reference to FIG. 10.

FIG. 10 is a conceptual diagram showing detection system 1 of the second exemplary embodiment.

FIG. 10 shows a state in which a parameter included in the request is determined as invalid information by controller 51 (second controller) of web application device 5 and this invalid information is transmitted to analysis receiver 33. In addition, the number of failures of the login authentication from web client 9 in FIG. 1 is set as less than three. When the login authentication fails, a response including invalid information is transmitted to analysis receiver 33.

Analysis receiver 33 receives the response including the invalid information to analyze the information on the header of the response (S21). The information analyzed by analysis receiver 33 branches into a step of invalid information (S22) and a step of valid information (S23). Step S21 corresponds to step S11 in FIG. 9. Analysis receiver 33 transmits the invalid information to generation unit 37.

When receiving the invalid information from the step of invalid information (S22), generation unit 37 generates a signature based on the invalid information (S24). Step S24 corresponds to step S12 in FIG. 9. Generation unit 37 transmits the generated signature to regulation unit 39. In a signature, parameters, error condition, the number of failures of the current login authentication, and the like are stored. Regulation unit 39 defines a signature based on the invalid information generated by generation unit 37 (S25). Controller 41 (first controller) stores this regulation generated by regulation unit 39 in storage unit 35 (first storage unit) (S40).

In the analysis of the information on the response header (S21), in the case of step S23 of analysis receiver 33 receiving the response including valid information, the result of login authentication is analyzed from the response header (S31). The result of the login authentication analyzed by analysis receiver 33 branches into approval of login authentication from web client 9 (S32), blocking of login authentication due to the number of times of login authentication from web client 9 reaching three or more (S33), and the number of failures of login authentication (S34) Step S31 also corresponds to step S11 in FIG. 9. Analysis receiver 33 transmits a result of any one of approval of login authentication, blocking of login authentication, and the number of failures of login authentication to regulation unit 39

Regulation unit 39 receives the result of login authentication from analysis receiver 33 and determines whether or not the result includes approval of login authentication (S35). Step S25 corresponds to step S13 in FIG. 9. In regulation unit 39, the number of failures of login authentication is set to be less than three (S36). Regulation unit 39 determines whether or not the number of failures of login authentication is less than 3 (S37).

If the number of failures of login authentication is less than two (YES in S37), one is added as the number of failures of login authentication (S38), and controller 41 stores a parameter included in the user's response in storage unit 35 (S40). Step S40 corresponds to step S14 in FIG. 9. Controller 41 transmits the failure of login authentication to web client 9.

In addition, if the number of failures of login authentication is three in step S38, the branch in step S31 proceeds to the blocking of login authentication in step S33 in the next login authentication. In this case, the process proceeds from step S35 to step S37, and to NO in step S37. Controller 41 registers a regulation for blocking a parameter included in the user's response (S39) to store in storage unit 35 (S40). Specifically, controller 41 updates the regulation for filtering in order to block the parameter included in the user's response (S40). Thus, in the future, the third and subsequent login authentication by the user is blocked. Controller 41 transmits the failure of login authentication to web client 9.

If the login authentication from web client 9 is approved (YES in S35), regulation unit 39 updates the regulation in storage unit 35 (S40). In addition, for example, if login authentication succeeds in the first time in a response including valid information, the branch in step S31 proceeds to the approval of login authentication in step S32, and to YES in step S35. Then, the regulation is updated in storage unit 35. It should be noted that if the first login authentication succeeds, the response of approval of login authentication may be transmitted to the web client in step S32 without going through regulation unit 39.

It should be noted that when the login authentication is approved, a signal may be transmitted to storage unit 35 so as to clear the number of failures of the login authentication stored in storage unit 35. Then, storage unit 35 may be updated by the information that the number of failures is zero.

Also in the second exemplary embodiment, other operations and effects have the same operations and effects as in the first exemplary embodiment.

### Other Modifications and the Like

As described above, the detection system, the web application device, the web application firewall device, the detection method for the detection system, the detection method for the web application device, and the detection method for the web application firewall device according to the present exemplary embodiment are described based on the first and second exemplary embodiments, but the present disclosure is not limited to the first and second exemplary embodiments.

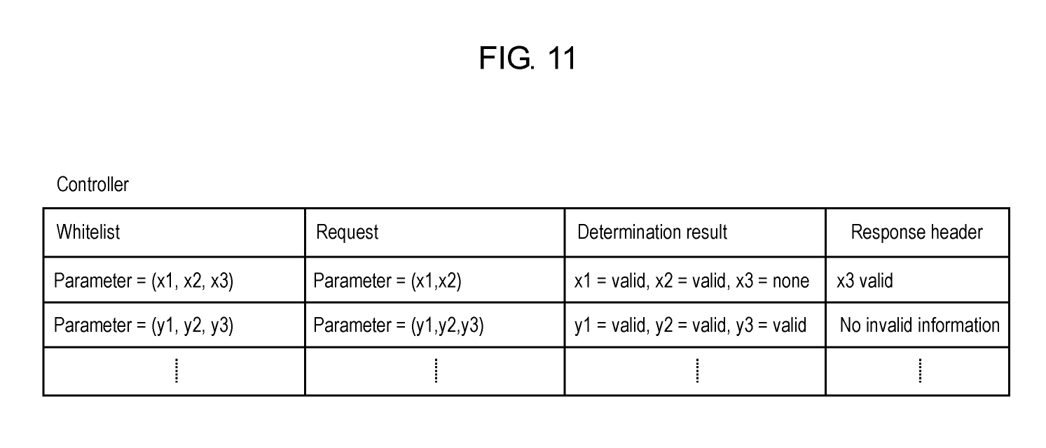

FIG. 11 is an explanatory diagram showing a determination of a controller of a web application device in a detection system. As shown in FIG. 11, in the first and second exemplary embodiments, when the specification of the web application device is changed and a parameter y3 is added to the whitelist parameters as compared with the case in FIG. 6, and when the parameters of the request are y1 and y2, the determination result of the controller is set that there is no parameter y3. Even in this case, the controller may register the parameter y3 as valid information in the response header.

It should be noted that in the first and second exemplary embodiments, even if a parameter is registered in the blacklist, this parameter may be deleted from the blacklist (cancellation of filtering by the determination unit). In addition, also for the whitelist, addition, change, and the like may be performed on the whitelist.

As described above, the first and second exemplary embodiments are described as an example of the technique in the present disclosure. The accompanying drawings and the detailed description are provided for that purpose.

Accordingly, some of the components described in the accompanying drawings and the detailed description may include not only components essential for solving the problem but also components not essential for solving the problem in order to illustrate the above technique. For this reason, it should not be recognized that these non-essential components are essential directly because these non-essential components are described in the accompanying drawings and the detailed description.

In addition, since the above-described first and second exemplary embodiments are used for illustrating the technique in the present disclosure, various changes, substitutions, additions, omissions, and the like can be made within the scope of claims or their equivalents.

### INDUSTRIAL APPLICABILITY

The present disclosure is useful for detection systems included in home appliances such as televisions and refrigerators, vehicles, and the like for transmitting and receiving information.

### REFERENCE MARKS IN THE DRAWINGS

1 detection system
3 web application firewall device
5 web application device
31 determination unit
33 analysis receiver
35 storage unit (first storage unit)
37 generation unit
39 regulation unit
41 controller (first controller)
51 controller (second controller)
53 response generation unit
55 storage unit (second storage unit)

1. A detection system comprising:
a web application firewall device configured to filter a request from a web client; and
a web application device configured to transmit a response corresponding to the filtered request,
the web application firewall device including:
a first controller configured to receive the request sent from the web client to determine whether or not the request is valid; and
an analysis receiver configured to receive the response corresponding to the filtered request from the web application device to analyze the response,
the web application device including:
a second controller configured to receive the filtered request transmitted from the web application firewall device to determine whether or not the request is valid; and
a response generation unit configured to generate the response corresponding to the filtered request to transmit the response to the web application firewall device,
the response corresponding to the filtered request including a determination result as to whether or not the filtered request is valid,
the first controller including:
a determination unit configured to receive the request including a parameter sent from the web client to determine whether or not the request includes the parameter being invalid;
a first storage unit configured to be storing data for filtering the request including the parameter being invalid of the web client; and
a generation unit configured to generate the data,
wherein when the analysis receiver extracts invalid information being information on the parameter being invalid from the response, the determination unit blocks the request including the parameter being invalid by updating the data stored in the first storage unit to filter the request,
wherein when extracting the invalid information from the response, the analysis receiver transmits the invalid information to the generation unit, and
wherein the generation unit generates the data from the invalid information and the parameter being invalid.

2. The detection system according to claim 1, wherein
the second controller receives the filtered request including the parameter transmitted from the web application firewall device to determine whether or not the filtered request includes the parameter being valid, and
the response generation unit selectively generates the response including the invalid information and the response including valid information being information on the parameter being valid to transmit to the web application firewall device.

3. A web application device configured to transmit a response corresponding to a filtered request, the web application device comprising:
a second controller configured to receive the filtered request including a parameter transmitted from a web application firewall device to determine whether or not the filtered request includes the parameter being valid; and
a response generation unit configured to generate the response corresponding to the filtered request to transmit the response to the web application firewall device,
wherein when the second controller determines that the parameter is invalid, the response generation unit stores invalid information being information on the parameter being invalid in the response, and when the second controller determines that the parameter is valid, the response generation unit stores valid information being information on the parameter being valid in the response, and
wherein the response generation unit generates the response including the invalid information or the response including the valid information to transmit to the web application firewall device.

4. A web application firewall device configured to filter a request from a web client, the web application firewall device comprising:
a first controller configured to receive the request sent from the web client to determine whether or not the request is valid;
an analysis receiver configured to receive a response from a web application device to analyze the response; and
a first storage unit configured to store data for blocking the request of the web client,
the first controller including:
a determination unit configured to receive the request including a parameter sent from the web client to determine whether or not the request includes the parameter being invalid;
a generation unit configured to generate a signature for blocking the parameter being invalid from the request; and
a regulation unit configured to store a regulation for blocking the parameter being invalid from the signature in the first storage unit,
wherein when invalid information is extracted from the response sent from the web application device, the analysis receiver transmits the invalid information to the generation unit.

5. The web application firewall device according to claim 4, wherein when invalid information in the response sent from the web application device is extracted, the analysis receiver transmits the invalid information to the generation unit or the regulation unit.

6. A detection method for a detection system including: a web application firewall device configured to filter a request from a web client; and a web application device configured to transmit a response corresponding to the request being filtered, the detection method comprising:
in the web application firewall device,
a first determination step of receiving the request including a parameter sent from the web client to determine whether or not the request includes the parameter being valid; and
an analysis reception step of receiving the response corresponding to the filtered request from the web application device to analyze the response,
wherein in the first determination step, when invalid information being information on the parameter being invalid is extracted from the response in the analysis reception step, data for filtering the parameter is updated,
the detection method for a detection system further comprising: in the web application device,
a second determination step of receiving the filtered request including the parameter transmitted from the web application firewall device to determine whether or not the filtered request includes the parameter being valid; and
a response generation step of generating a response corresponding to the filtered request to transmit the response to the web application firewall device,
wherein in the response generation step, the response including the invalid information or the response including valid information being information on the parameter being valid is generated to be transmitted to the web application firewall device.

7. A detection method for a web application device configured to transmit a response corresponding to a filtered request, the detection method for a web application device comprising
transmitting the response including information for filtering a request from the web application device to a web application firewall device, the response including the information in a header.

8. A detection method for a web application firewall device configured to filter a request from a web client, the detection method for a web application firewall device comprising
when an analysis receiver configured to receive a response including, in a header, information for filtering the request from a web application device to analyze extracts invalid information being information on an invalid parameter from the response, updating data for filtering the request.
